(19) United States
(12) Patent Application Publication
(10) Pub. No.: US 2010/0162374 A1
(43) Pub. Date: Jun. 24, 2010

(54) COST EFFECTIVE UPDATING OF MOBILE COMPUTING DEVICES AND COMMUNICATING WITH MOBILE COMPUTING DEVICES

(76) Inventor: Jiji U. Nair, Santa Clara, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 12/463,135

(22) Filed: May 8, 2009

Related U.S. Application Data
(60) Provisional application No. 61/139,504, filed on Dec. 19, 2008.

(51) Int. Cl. G06F 15/177; H04L 9/32

(52) U.S. Cl. 726/7; 717/172

(57) ABSTRACT

A system and a method for updating mobile computing devices with an update package and for exchanging information on an exclusive channel between the mobile computing device provider and the mobile computing device user. The method comprises publishing a first update package available for the first group, updating the first group, then publishing a second update package available message for the second group and updating the second group. The method also comprises establishing a private channel between the mobile computing device and the mobile computing device provider, and exchanging information on the private channel.

### CROSS-REFERENCE TO RELATED APPLICATION

This application claims a benefit of, and priority to, U.S. Patent Application Ser. No. 61/139,504, filed Dec. 19, 2008, the content of which is incorporated by reference herein.

### BACKGROUND

1. Field of Art

The disclosure generally relates to the field of mobile communication, and more specifically, to communications with mobile communication devices.

2. Description of the Related Art

Mobile computing devices today are more versatile than ever. An end user uses a mobile computing device today not only to make phone calls, but also to perform other functions such as message other users, send and receive emails, shop, and calendar events. As the mobile computing device becomes more versatile, the operating system and software running on the device becomes more complicated. The mobile computing device, therefore, may need multiple updates to its operating system and other software after the device is shipped to the user.

Traditionally, the mobile computing device operators have used Short Message Service (SMS) to inform the user's device that an update is available. The device may then prompt the user about the update and request the user to download the update. While this SMS technique of informing the user gets updates information to the user, the technique ends up costing the mobile computing device providers substantial amount of money (e.g., millions of dollars (U.S.)) in updating the phone. For example, mobile phone providers pay a fee (e.g., 2-5 cents (U.S.)) for every SMS message they send to the user. With an install base that may number millions, updating tens of millions of phones few times a year is extremely costly.

Additionally, SMS messaging often lacks security to exchange information with the end user. SMS messaging is vulnerable to SMS spoofing. Hence, users are reluctant to share confidential information through SMS messaging.

### SUMMARY

One embodiment discloses a process (and system) for mobile service providers to update software on mobile phones. The process load balances the update server by ensuring that the update server does not update every group of mobile devices at the same time. Groups of mobile phones are subscribers of separate topics published by the provider. The mobile phones provide information to provider about the application versions on mobile phones through these topics. The provider determines an update package based on the received information, compiles the update package, and informs various groups of mobile devices one at a time (see claim 2). The mobile devices on being informed, request the update and the provider pushes the compiled update package to the mobile device.

Additionally, the messaging server establishes a private communication channel with every mobile computing device. This communication channel is an exclusive channel between the mobile computing device provider and the mobile computing device user. The provider and the user may exchange confidential and other information such as a user's confidential billing information on this channel.

In one embodiment, the messaging server sends an “update package available” message to a first group of mobile computing devices. The mobile computing devices from first group then requests the update package from the update server and the update server updates the mobile computing devices. After many of the mobile computing devices from the first group have been updated, the messaging server sends the “update package available” message to a second group of mobile computing devices. The second group of mobile computing devices is then updated in the same manner as the first group. In this manner, the update server updates one group of users at a time and therefore avoids any overloading issues. Moreover, the disclosed embodiment avoids the use of SMS or third party services and therefore cut the cost of updating mobile computing devices.

Additionally, the messaging server is configured to establish a private communication channel with each mobile computing device that it seeks to establish a secured communication channel. Thereafter, the mobile computing device provider and the mobile computing device user can exchange confidential and other information on this channel because no other user has access to this channel. Moreover, the communication channel is created in a manner that allows the mobile computing device provider to push messages to the mobile computing device without any requests for messages from the mobile computing device.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

The disclosed embodiments have other advantages and features which will be more readily apparent from the detailed description, the appended claims, and the accompanying drawings. The Figures include the following:

FIG. 1 illustrates one embodiment of a mobile computing device.

FIG. 2 illustrates one embodiment of architecture of a mobile computing device.

FIG. 3 illustrates one embodiment of pub-sub manager in more detail.

FIG. 4 illustrates one embodiment of system used for updating software on mobile computing device.

FIG. 5 illustrates a method for updating groups of mobile computing devices one at a time.

FIG. 6 illustrates a method for delivering a message to the intended recipient module in a mobile computing device.

FIG. 7 illustrates a method for establishing a private topic exclusively for a mobile computing device.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles disclosed herein.

Reference will now be made in detail to several embodiments, examples of which are illustrated in the accompanying figures. It is noted that wherever practicable, similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Exemplary Mobile Computing Device

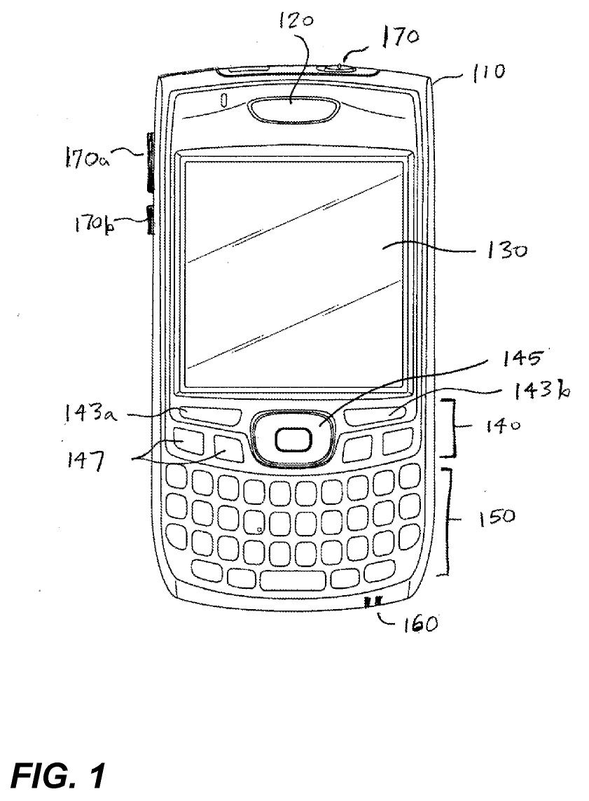

FIG. 1 illustrates one embodiment of a mobile computing device 110 with telephonic functionality, e.g., a mobile phone or a smartphone. The mobile computing device is configured to host and execute a phone application for placing and receiving telephone calls. It is noted that for ease of understanding the principles disclosed herein are in an example context of a mobile computing device 110 with telephonic functionality operating in a mobile telecommunications network. However, the principles disclosed herein may be applied in other duplex (or multiplex) telephonic contexts such as devices with telephonic functionality configured to directly interface with public switched telephone networks (PSTN) or data networks having voice over internet protocol (VoIP) functionality.

The mobile computing device 110 is configured to be of a form factor that is convenient to hold in a user's hand, for example, a personal digital assistant (PDA) or a smart phone form factor. For example, the mobile computing device 110 can have dimensions ranging from 7.5 to 15.5 centimeters in length, 5 to 12.75 centimeters in width, 0.64 to 2.2 centimeters in height and weigh between 50 and 250 grams.

The mobile computing device 110 includes a speaker 120, a screen 130, a navigation area 140, a keypad area 150, and a microphone 160. The mobile computing device 110 also may include one or more switches 170, 170a, and 170b (generally 170). The one or more switches 170 may be buttons, sliders, or rocker switches and can be mechanical or solid state (e.g., touch sensitive solid state switch).

The screen 130 of the mobile computing device 110 is, for example, a 240×240, a 320×320, or a 320×480 transflective display. In alternative embodiments, the aspect ratios and resolution may be different without departing from the principles of the inventive features disclosed within the description. By way of example, embodiments of the screen 130 comprises an active matrix liquid crystal display (AMLCD), a thin-film transistor liquid crystal display (TFT-LCD), an organic light emitting diode (OLED), an interferometric modulator display (IMOD), a liquid crystal display (LCD), or other suitable display device. In an embodiment, the display displays color images. In another embodiment, the screen 130 further comprises a touch-sensitive display (e.g., pressure-sensitive (resistive), electrically sensitive (capacitive), acoustically sensitive (SAW or surface acoustic wave), photo-sensitive (infra-red)) including a digitizer for receiving input data, commands or information from a user. The user may use a stylus, a finger or another suitable input device for data entry, such as selecting from a menu or entering text data.

The navigation area 140 is configured to control functions of an application executing in the mobile computing device 110 and visible through the screen 130. For example, the navigation area includes an x-way (x is a numerical integer, e.g., 5) navigation ring 145 that provides cursor control, selection, and similar functionality. In addition, the navigation area 140 may include selection buttons 143a, 143b to select functions viewed just above the buttons on the screen 130. In addition, the navigation area 140 also may include dedicated function buttons 147 for functions such as, for example, a calendar, a web browser, an e-mail client or a home screen. In this example, the navigation ring 145 may be implemented through mechanical, solid state switches, dials, or a combination thereof. The keypad area 150 may be a numeric keypad (e.g., a dialpad) or a numeric keypad integrated with an alpha or alphanumeric keypad or character keypad 150 (e.g., a keyboard with consecutive keys of Q-W-E-R-T-Y, A-Z-E-R-T-Y, or other equivalent set of keys on a keyboard such as a DVORAK keyboard or a double-byte character keyboard).

Although not illustrated, it is noted that the mobile computing device 110 also may include an expansion slot. The expansion slot is configured to receive and support expansion cards (or media cards), which may include memory cards such as CompactFlash™ cards, SD cards, XD cards, Memory Sticks™, MultiMediaCard™, SDIO, and the like.

### Exemplary Mobile Computing Device Architectural Overview

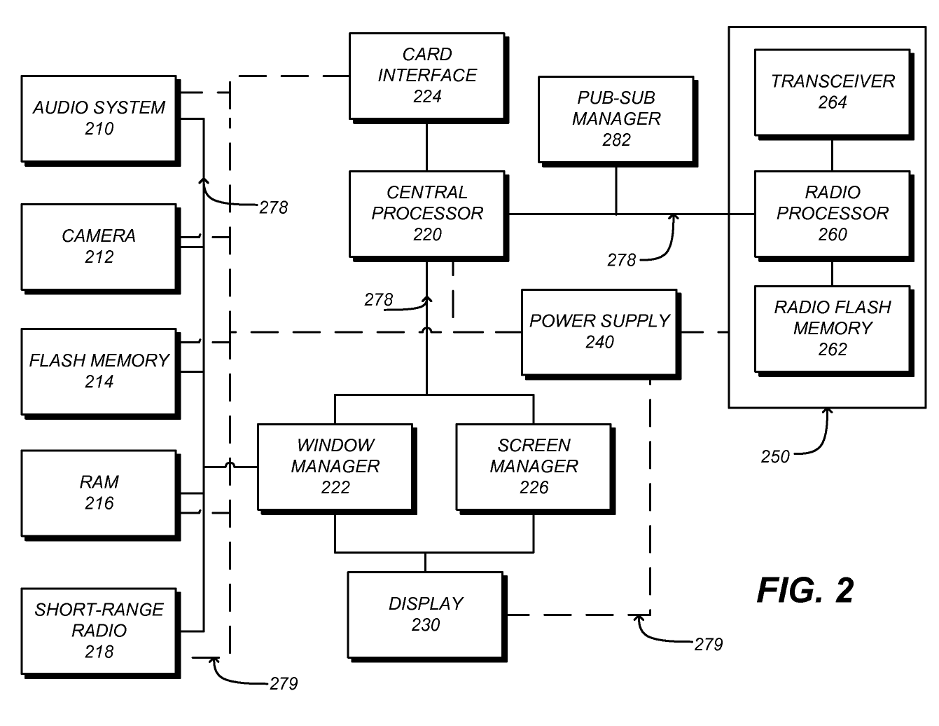

Referring next to FIG. 2, a block diagram illustrates one embodiment of architecture of a mobile computing device 110, with telephonic functionality. By way of example, the architecture illustrated in FIG. 2 will be described with respect to the mobile computing device of FIG. 1. The mobile computing device 110 includes a central processor 220, a power supply 240, and a radio subsystem 250. The central processor 220 communicates with: audio system 210, camera 212, flash memory 214, RAM memory 216, short range radio module 218 (e.g., Bluetooth, Wireless Fidelity (WiFi) component), a window manager 222, a pub-sub manager 282 and a screen manager 226. The power supply 240 powers the central processor 220, the radio subsystem 250 and a display driver 230 (which may be contact- or inductive-sensitive). The power supply 240 may correspond to a battery pack (e.g., rechargeable) or a powerline connection or component. The power supply 240 powers the various components through a power line (or bus) 279.

In one embodiment, the window manager 222 comprises a software, firmware, hardware or blended implementation of a process that initializes a virtual display space stored in the RAM 216 and/or the flash memory 214. The virtual display space includes one or more applications currently being executed by a user and the current status of the executed applications. The window manager 222 receives requests, from user input or from software or firmware processes, to show a window and determines the initial position of the requested window. Additionally, the window manager 222 receives commands or instructions to modify a window, such as resizing the window, moving the window or any other command altering the appearance or position of the window, and modifies the window accordingly.

The screen manager 226 comprises a software or firmware process that manages content displayed on the screen 130. In one embodiment, the screen manager 226 monitors and controls the physical location of data displayed on the screen 130 and which data is displayed on the screen 130. The screen manager 226 alters or updates the location of data as viewed on the screen 130. The alteration or update is responsive to input from the central processor 220 and display driver 230, which modifies appearances displayed on the screen 130. In one embodiment, the screen manager 226 also monitors and controls screen brightness and transmits control signals to the central processor 220 to modify screen brightness and power usage to the screen 130.

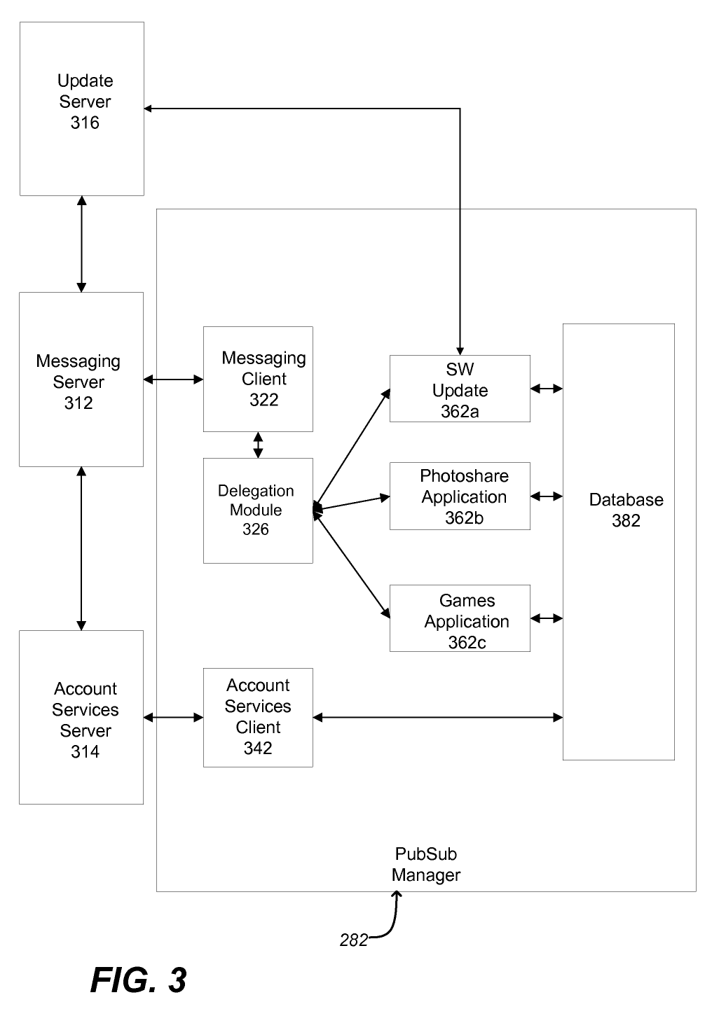

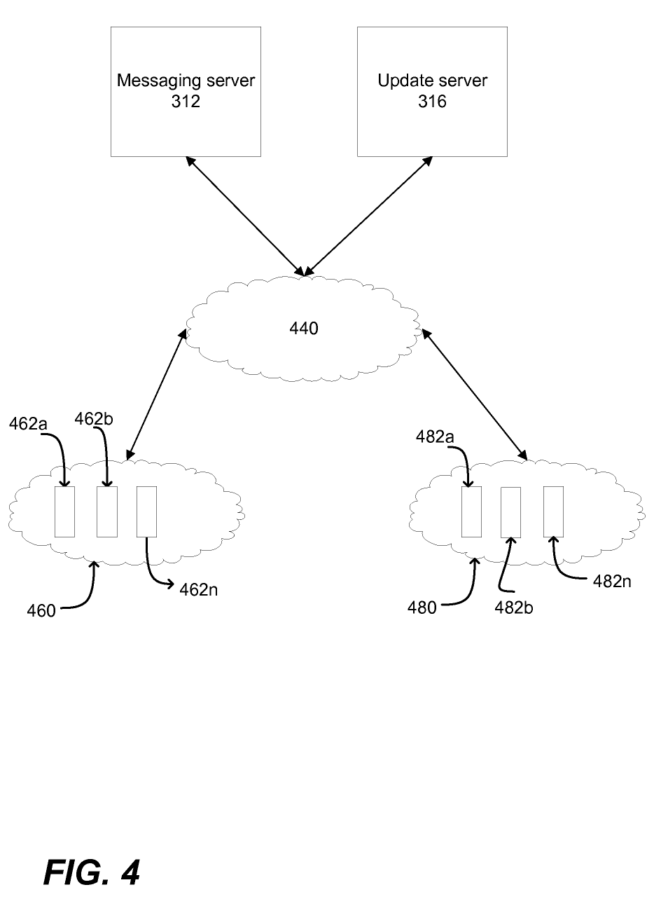

The publication subscription (pub-sub) manager 282 comprises software, hardware, firmware or blended implementation of a process that manages information exchange with external servers or other clients. In one embodiment, the pub-sub manager 282 gets a message from an update server informing the device that an update is available. In another embodiment, the pub-sub manager receives confidential and other information like billing information from account services. The pub-sub manager 282 processes the received information and displays the update information or billing information on screen 130. The pub-sub manager 282 is described in more detail in FIG. 3 and FIG. 4.

The radio subsystem 250 includes a radio processor 260, a radio memory 262, and a transceiver 264. The transceiver 264 may be two separate components for transmitting and receiving signals or a single component for both transmitting and receiving signals. In either instance, it is referenced as a transceiver 264. The receiver portion of the transceiver 264 communicatively couples with a radio signal input of the device 110, e.g., an antenna, where communication signals are received from an established call (e.g., a connected or on-going call). The received communication signals include voice (or other sound signals) received from the call and processed by the radio processor 260 for output through the speaker 120 (or 184). The transmitter portion of the transceiver 264 communicatively couples a radio signal output of the device 110, e.g., the antenna, where communication signals are transmitted to an established (e.g., a connected (or coupled) or active) call. The communication signals for transmission include voice, e.g., received through the microphone 160 of the device 110, (or other sound signals) that is processed by the radio processor 260 for transmission through the transmitter of the transceiver 264 to the established call.

In one embodiment, communications using the described radio communications may be over a voice or data network. Examples of voice networks include Global System of Mobile (GSM) communication system, a Code Division, Multiple Access (CDMA system), and a Universal Mobile Telecommunications System (UMTS). Examples of data networks include General Packet Radio Service (GPRS), third-generation (3G) mobile, High Speed Download Packet Access (HSDPA), High Speed Uplink Packet Access (HSUPA), and Worldwide Interoperability for Microwave Access (WiMAX).

While other components may be provided with the radio subsystem 250, the basic components shown provide the ability for the mobile computing device to perform radio-frequency communications, including telephonic communications. In an embodiment, many, if not all, of the components under the control of the central processor 220 are not required by the radio subsystem 250 when a telephone call is established, e.g., connected or ongoing. The radio processor 260 may communicate with central processor 220 using a data line (or bus) 278.

The card interface 224 is adapted to communicate with the expansion slot. The card interface 224 transmits data and/or instructions between the central processor and an expansion card or media card included in the expansion slot. The card interface 224 also transmits control signals from the central processor 220 to the expansion slot to configure an expansion card or media card included in the expansion slot.

In one embodiment, central processor 220 executes logic (by way of programming, code, instructions) corresponding to executing applications interfaced through, for example, the navigation area 140 or switches 170. It is noted that numerous other components and variations are possible to the hardware architecture of the computing device 200, thus an embodiment such as shown by FIG. 2 is just illustrative of one implementation for an embodiment.

### Exemplary Pub-Sub Manager Architecture

Referring now to FIG. 3, a block diagram illustrates one embodiment of a pub-sub (publication-subscription) manager 282. The diagram includes illustrations of modules (shown as boxes) in the pub-sub manager 282. The modules are logical modules implementing various functions in a pub-sub manager 282. In another embodiment, these modules may be referred by another name or the functionality of certain modules may be combined into some other module without departing from the spirit of the disclosed configurations. These modules are logical modules that may be implemented in software, hardware, firmware or a blend of the three implementations. As software or firmware, the modules are implemented as instructions that are executable by a processor (e.g., processor 220).

The pub-sub manager 282 includes a messaging client 322, a delegation module 326, an account services client 342, a software update module 362a, a photoshare application module 362b, a games application module 362c and a database 382. The pub-sub manager 282 communicatively couples to an update server 316, messaging server 312 and account services server 314. The update server 316 communicatively couples to messaging server 312 and software update module 362a. The messaging server 312 communicatively couples to update server 316, account services server 314 and messaging client 322. The account services server 314 communicatively couples to messaging server 312 and account services client 342.

The messaging client 322 communicatively couples to delegation module 326 and messaging server 312. The delegation module 326 communicatively couples messaging client 322, software update module 362a, photoshare application module 362b and games application module 362c. The account services client 342 communicatively couples to account services server 314 and database 382. The software update module 362a communicatively couples to update server 316, delegation module 326 and database 382. The photoshare application module 362b communicatively couples to database 382 and delegation module 326. The games application module 362c communicatively couples to delegation module 326 and database 382. The database 382 communicatively couples to software update module 362a, photoshare application module 362b and games application module 362c.

The messaging client 322 sends and receives messages from external servers or other devices. The messaging client may implement various messaging protocols, for example, EXTENSIBLE MESSAGING AND PRESENCE PROTOCOL (XMPP), CSPACE, GADU-GADU, IRC, MECA NETWORK, MICROSOFT NOTIFICATION PROTOCOL, PSYC, RETROSHARE, TOC PROTOCOL, TOC2 PROTOCOL, SIP/SIMPLE, YMSG, DIRECTNET, ZEPHYR NOTIFICATION SERVICE, or SKYPE PROTOCOL.

The messaging client 322 communicatively couples to delegation module 326. The delegation module 326 parses the message and determines the destination module for the message. The destination modules can be services or application modules for example, a software update module 362a, photoshare application module 364b, or games application module 364c. As noted previously, these modules are software, firmware, hardware or a blended implementation of various logical modules that correspond to different applications or services. For example, the software update module 362a implements the functionality for software updating service on the mobile computing device 110, and the photoshare application 362b enables a user to share her photos with other users. The games application module 362c manages all the games on the mobile computing device 110. The database 382 contains data for the modules in the pub-sub manager 282 and the database 282 is communicatively coupled with the application services modules 362 and the account services client 342. The account services client module communicates with the account services server 314 during initialization and at other times.

The account services server 314 communicates with the account services client to exchange information like identification tag and password for the device. The account services server 314 may be software, firmware, hardware or blended implementation of an account services server. The account services server 314 communicatively couples to account services client 342 and messaging server 312. The messaging server 312 is software, firmware, hardware or blended implementation of a messaging server. The messaging server 312 may implement various messaging protocols, for example, XMPP, CSPACE, GADU-GADU, IRC, MECA NETWORK, MICROSOFT NOTIFICATION PROTOCOL, PSYC, RETROSHARE, TOC PROTOCOL, TOC2 PROTOCOL, SIP/SIMPLE, YMSG, DIRECTNET, ZEPHYR NOTIFICATION SERVICE, or SKYPE PROTOCOL. The messaging server 312 communicatively couples to the account services server 314 and update server 316.

The update server 316 is software, firmware, hardware or blended implementation that executes the functionality of an update server. The update server 316 contains the update software for mobile computing devices and transmits the update software to mobile computing devices. In one embodiment, the update software resides on a database and the update server 316 transmits the update software from the database to mobile computing devices.

### Exemplary Updating Software Configuration

Referring now to FIG. 4, one embodiment of the system used for updating software on mobile computing device is illustrated. The system includes a messaging server 312, an update server 316, a first network cloud 440, a second network cloud 460 and a third network cloud 480. The first network cloud 440 communicatively couples the messaging server 312, the update server 316, and the second and third network clouds 460, 480. The first network cloud 440 is a network that enables various entities within the network or connected with the network to communicate with each other. The first network cloud 440 can be a wireless network, a LAN network, or a blend of these and other networks. The messaging server 312 communicatively couples to other components in the system through the network cloud 440. The update server 316 is communicatively coupled to other components in the system through the first network cloud 440.

The second and third network clouds 460 and 480 are logical groupings of mobile computing devices and other entities that may be grouped together based on one or more criteria. In one embodiment, the second and third network clouds 460 and 480 include mobile computing devices and other network entities located in a particular geographical location. For example, the second network cloud 460 can represent a group of mobile computing devices in the United Kingdom (UK) and the third network cloud 480 can represent a group of mobile computing devices in United States (US). Further, each network cloud 460, 480 may include one or more devices 462a-n, 482a-n (n being any integer value greater than 0). The mobile computing devices 462a-n (generally 462) and 482a-n (generally 482) are n number of mobile computing devices in second network cloud 460 and third network cloud 480 where n represents any integer. The mobile computing devices 462 and 482 can be any mobile computing device that is functionally similar to mobile computing device 110 with similar architecture as the one represented in FIG. 2 including a pub-sub manager of FIG. 3. The mobile computing devices 462a-n and 482a-n are communicatively coupled to the messaging server 312 and update server 316 through the first network cloud 440.

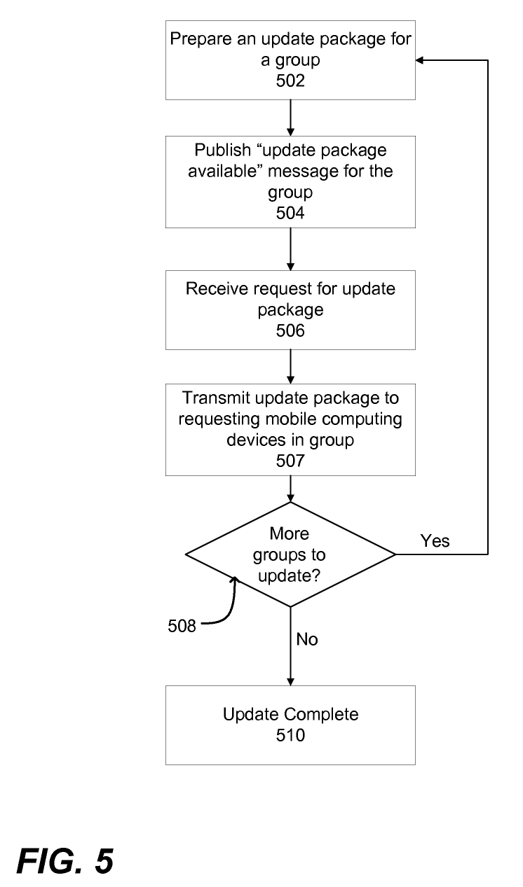

Referring now to FIG. 5, a process for updating groups of mobile computing devices 462a-n and 482a-n is illustrated. In one embodiment, the update server 316 keeps track of the latest software version sent by the update server 316 to a mobile computing device 462a and 482a. In another embodiment, the update server keeps track of the latest version sent by the update server 316 to the second cloud network 460 and third cloud network 480. In yet another embodiment, the mobile computing devices 462a-n, 482a-n transmit the information about the software, firmware and/or software application present on the mobile computing devices 462a-n, 482a-n to the update server 316. This information may include a software version number and/or the list of features supported by the current mobile computing device software. The update server uses this mobile computing device software information to determine the required update package for the mobile computing device 462a-n, 482a-n.

Regardless of how the update server 316 determines the required update software package, the update server 316 next prepares 502 the update package for mobile computing devices. In one embodiment, the update package is prepared as a software payload by another entity in the system. The assembled update package (or software payload) includes the update software or an online address for location of the update software. The update package is then delivered to the update server 316. Regardless of how the update server 316 gets the update package, the update server 316 or some other entity in the system then informs the messaging server 312 about the availability of a new software payload that is ready for distribution. In one embodiment, the messaging server 312 itself determines that an update package is available.

Regardless of how the messaging server 312 finds out about the update package, the messaging server 312 next publishes 504 an “update package available” message indicating that an update package is available for distribution to mobile computing devices. The messaging server 312 publishes the update package available message for one group of mobile computing devices at a time e.g., 462a-n or 482a-n.

There are a number of ways to ensure that the update package available message is distributed to one group of mobile computing devices 462 and 482 at a time. In one embodiment, the messaging server and the mobile computing devices 462 and 482 use the XEP-0060 protocol extension of XMPP to exchange messages. The messaging server 312 creates nodes or topics for mobile computing devices 462 and 482 on a pubsub service. The mobile computing devices 462a-n subscribe to a first topic and mobile computing devices 482a-n subscribe to a second topic. In one embodiment the mobile computing devices 462 and 482 are preconfigured with subscription to various topics. In another embodiment, the mobile computing devices 462 ad 482 subscribe to various topics during initialization.

It is noted that in one embodiment, a topic comprises an object that defines the relationship between a publisher and its subscribers. Further, in one embodiment, a topic includes a description of the information that will be provided, a list of subscribers to items that fit the description, and one or more items that fit the description. The item in one embodiment comprises an instance of data published by the publisher that fits the description associated with the topic. Each item may possess a unique identifier that enables the data to be tracked. It is noted that a topic may be addressed by means of a unique topic identification (or identifier or ID). A topic ID can be a string that may have semantic meaning (e.g., ‘/mobiledevice/smartphone/GSM’ or ‘carrier.att.phone’), but is not necessary (i.e., the topic ID may be any random string (e.g., ‘algh83jfn342092’)). It is also noted that generally the topic ID is unique within the context of a specific pub-sub domain (e.g., pubsub.distributor.org).

Irrespective of how and when the mobile computing devices 462 and 482 subscribe to their respective topics, the messaging server 312 can publish the update package available message on one topic at a time. For example, the messaging server 312 first publishes the update package available message with the first topic for mobile computing devices 462a-n in cloud 460. In this example, the mobile computing devices 482a-n are not subscribed to the first topic and do not yet get this update available message and are not yet instructed about obtaining any available updates at the time. The messaging server 312 next publishes the update package available message with the second topic for mobile computing devices 482a-n in cloud 480.

In one embodiment, the messaging server 312 publishes a message on more than one topic at a time and send message to more than one group of mobile computing device 462 and 482 at a time. In this manner, the messaging server 312 can send the update package available message to one or more group of mobile computing devices at a time.

The mobile computing devices 462a-n, after receiving the update available message, request the update package software from the update server 316. The update server 316 receives 506 the request and transmits 507 the update package to the requesting mobile computing devices 462a-n. The mobile computing device 462a-n receiving the update package either installs the software update within the package or directs itself to the link within to download and install update software. In one embodiment, the update server 316 transmits 507 the update package to mobile computing devices 462a-n periodically without receiving any requests from the mobile computing devices.

In one embodiment, the update server 316 compiles the update software in the update package and provides the mobile computing devices 462a-n with the compiled version of the update software in the update package. The mobile computing devices therefore do not have to compile the update software before integrating the update software with existing software on the mobile computing devices.

There may be instances where a mobile computing device 462a-n does not get the update package. For example, the mobile computing device 462a-n may not get the update package because the mobile computing device did not have any signal reception when the update package was transmitted. In one embodiment, the mobile computing device 462a-n requests the update package again after a pre-determined time period from the update server 316 if the mobile computing device 462a-n received the update package available message and requested an update package but did not receive the update package.

In another embodiment, the mobile computing devices 462a-n after receiving the update package transmit a message to update server 316 with information on whether the mobile computing devices 462a-n have updated with the new update software in the update package.

The update server 316 tracks the mobile computing devices 462a-n that have been updated and the mobile computing devices 462a-n that still need to be updated. The update server 316 can resend after a pre-determined time period the update package available message to the mobile computing devices 462a-n that did not update earlier.

After the update server 316 has completed updating all or many of the mobile computing devices 462a-n, the messaging server 312 next determines 508 if any other group of devices should be updated. In one embodiment, this determination may be performed by the update server 316 or some other entity in the system. Regardless of which entity performs the check, the entity determines that mobile computing devices 482a-n need the update and the messaging server 312 prepares 502 the update package available message for mobile computing devices 482a-n. The mobile computing devices 482a-n, after receiving the update available message, contact the update server 316 and the update server 316 transmits the update to 506 the mobile computing devices 482a-n. The messaging server 312, update server 316 or some other entity now determines that no other group of devices need to be updated and the update is therefore complete 510.

The disclosed embodiment manages the load on the update servers 316 by updating various groups of mobile computing devices at different times. Moreover, the disclosed embodiment beneficially pushes the update message and update-software to the mobile computing devices instead of waiting for the mobile computing devices to request or pull the update software from the update server 316. In one embodiment, pushing the update software is more beneficial because the mobile computing devices 462, 482 do not need to constantly poll the update servers 316 for an update and the update servers 316 have more control on when to update various devices and therefore avoid overloading. Additionally, the disclosed embodiment avoids the use of SMS or other third-party services that add to the cost of updating mobile computing devices, for example, via mobile carrier transport medium.

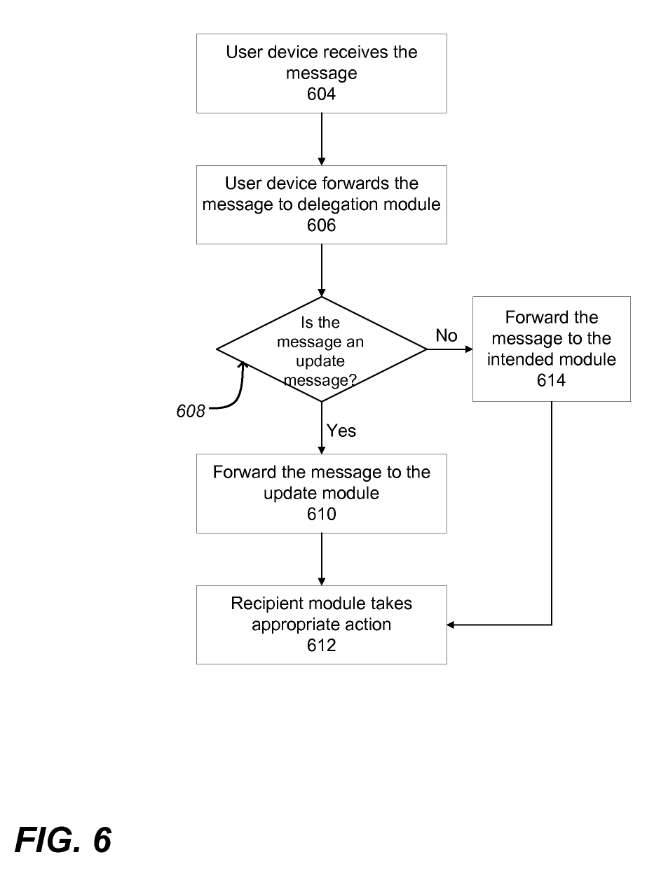

Referring now to FIG. 6, a process for delivering a message to the intended recipient module in a mobile computing device e.g., 462, 482 is disclosed. After the mobile computing device e.g., 462 receives 604 a message like update message, the device forwards 606 the message to the delegation module 326 in the mobile computing device. The delegation module 326 then determines 608 the intended recipient module for the received message. If the received message is meant for the update module 362a, the delegation module 326 forwards 610 the message to the update module 362a. Otherwise, the delegation module 326 forwards 614 the message to other intended module. The intended module or the update module 362a receives the message and takes 612 appropriate actions in response to the received message.

There are a number of ways to ensure that the intended module is the recipient of the message. In one embodiment, the messaging server and the mobile computing devices use the XEP-0060 protocol extension of XMPP to exchange messages. The messaging server 312 creates a node or a topic on a pubsub service. Different modules in the mobile computing device subscribe to various topics on the service. When the messaging server 312 publishes a message on a particular topic, the message is pushed out to all subscriber modules. Because a topic can have multiple subscribers, the XEP-0060 extension allows a messaging server 312 to simultaneously push out a message to multiple modules or mobile computing devices 462, 482.

In one embodiment, the modules in a mobile computing device have unique application identification (appIDs). The messaging server 312 inserts this appID into the message and transmits the message to mobile computing devices. On receiving the message, the delegation module 326 parses the message, reads the appID and forwards the message to the module with the corresponding appID. Because appIDs are unique, this method allows the messaging server 312 to send a message to one particular module in the mobile computing device.

In another embodiment, the messaging server 312 may publish a message on a topic with multiple subscribers and the message may also contain an appID. The delegation module 326 on receiving the message will face the conflicting instructions of sending the message to all subscriber modules in the mobile computing device and sending the message to only the module with the corresponding appID. The delegation module 326 in such a case will send the message to only the module with the corresponding appID. In one embodiment, all subscriber modules, and not only the module with corresponding appID, get the message.

### Exemplary Exclusive Channel Configuration

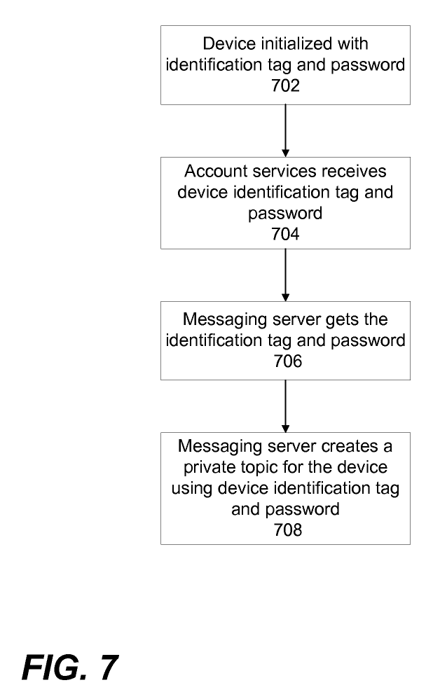

Referring now to FIG. 7, a process for establishing a private topic exclusively for a mobile computing device is disclosed. The mobile computing device is initialized 702 with a unique identification tag and a password. The account services client 342 transmits this identification tag and password to the account services server 314. On receiving 704 the identification tag and password, the account services server stores and relays this information to the messaging server 312. In one embodiment, the messaging server 312 polls the account services server 314 for the identification tag and password of a mobile computing device. In another embodiment, the account services server 314 stores the information in a database and the messaging server 312 retrieves 706 the information from the database. In another embodiment, the mobile computing device directly transmits the identification tag and password to the messaging server 312. Regardless of how the messaging server 312 gets the information, the messaging server next uses the identification tag and password to create and publish 708 a private topic for the mobile computing device. The mobile computing device can now subscribe to the private topic using the device's identification tag and password. Because no other device has the same identification tag and password, other devices cannot subscribe to the private topic and the private topic is an exclusive communication link between the messaging server and the device containing the unique identification tag and password.

Moreover, creation or ownership of the private topic is managed through the messaging server 312. The owner of the private topic can associate an attribute with the topic that causes any requesting subscribers to first authenticate themselves with the messaging server 312 before the device can join the topic. Accordingly, if a perpetrator (e.g., an unauthorized device attempting access to the topic) tries to join the private topic, the messaging server 312 will first authenticate the perpetrator, determine that the perpetrator does not belong to the private topic and deny perpetrator access to the private topic.

The disclosed embodiments beneficially provide an exclusive communication channel between a services provider and the mobile computing device. Additionally, the disclosed embodiments provide the mobile computing device provider with a channel to push confidential and other information to the mobile computing device user without requiring any action from the user. The mobile computing device provider may therefore push a user's billing information or payment reminders to the user without waiting to first get a request from the user. The mobile computing device user can also use the private topic to send confidential and other information to the service provider. Additionally, the disclosed embodiment avoids the use of SMS or other third-party services that add to the cost of updating mobile computing devices, for example, via mobile carrier transport medium.

### Additional Considerations

Some portions of above description describe the embodiments in terms of algorithms and symbolic representations of operations on information, for example, with respect to the functional operation and processes described in conjunction with FIGS. 2 through 7. These algorithmic descriptions and representations are commonly used by those skilled in the data processing arts to convey the substance of their work effectively to others skilled in the art. The process operations, while described functionally, computationally, or logically, are understood to be implemented by computer programs or equivalent electrical circuits, microcode, or the like. Furthermore, as noted previously with these Figures, the process operations and functional operation may be referenced as modules, without loss of generality. The described operations and their associated modules may be embodied in software, firmware, hardware, or any combinations thereof. As previously noted, the software or firmware may be embodied as instructions, which may be stored on a computer-readable storage medium (e.g., flash memory 214) and executable by a processor (e.g., processor 220).

As used within any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used within, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the configuration. This description should be read to include one or at least one and the singular also includes the plural unless it is obvious that it is meant otherwise.

Upon reading this disclosure, those of skill in the art will appreciate still additional alternative structural and functional designs for a system and a process for updating mobile computing devices and establishing a private communication channel between the mobile computing device user and the mobile computing device provider through the disclosed principles herein. Thus, while particular embodiments and applications have been illustrated and described, it is to be understood that the disclosed embodiments are not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A computer-implemented method for managing load on an update server, the update server to update software on mobile computing devices, the method comprising:
publishing a plurality of topics for a plurality of corresponding groups of mobile computing devices, wherein at least one mobile computing device of each group is pre-configured subscriber of at least one topic from the plurality of topics;
receiving, from the at least one mobile computing device, information about an application on the at least one mobile computing device;
determining an update package for the at least one mobile computing device using the received information;
compiling the update package for the at least one mobile computing device;
informing the at least one mobile computing device about the compiled update package through the at least one topic;
receiving an update request from the at least one mobile computing device; and
transmitting, in response to receiving the update request, the compiled update package to the at least one mobile computing device.

2. The computer implemented method of claim 1, wherein the informing further comprises informing in a sequential order the at least one mobile device of each group about the compiled update package.

3. The computer implemented method of claim 1, wherein publishing the plurality of topics is achieved through an implementation of XEP-0060 protocol.

4. The computer implemented method of claim 1, wherein the information about the application is a version number of the application.

5. The computer implemented method of claim 1, wherein each group of mobile computing devices comprises a group of mobile computing devices in a geographical location.

6. A computer-implemented method for exchanging information with a mobile computing device, the method comprising:
storing an identification tag and a password for the mobile computing device;
creating a private topic for the mobile computing device using the identification tag and the password;
publishing the private topic for the mobile computing device;
receiving, from the mobile computing device, the identification tag and the password;
granting a subscription to the private topic to the mobile computing device in response to the received identification tag and the password matching the stored identification tag and the stored password; and
transmitting information on the private topic to the mobile computing device.

7. The computer implemented method of claim 6, wherein the identification tag and the password uniquely identify the mobile computing device.

8. The computer implemented method of claim 6, wherein the information is billing information.

9. The computer implemented method of claim 6, wherein publishing the private topic is achieved through an implementation of XEP-0060 protocol.

10. The computer implemented method of claim 6, wherein the information is destined for a particular module in the mobile computing device and the information contains an appID corresponding to the particular module.

11. A computer-implemented method for managing load on an update server, the update server to update software on mobile computing devices, the method comprising:
publishing a plurality of topics for a plurality of groups of mobile computing devices;
transmitting a notification to at least one mobile computing device in each of the plurality of groups about an update package through a corresponding topic from the plurality of topics; and
transmitting the update package to the at least one mobile computing device.

12. The computer implemented method of claim 11, wherein the informing further comprises informing in a sequential order the at least one mobile device of each group about the compiled update package.

13. The computer implemented method of claim 11, further comprising:
receiving, from the at least one mobile computing device, information about an application on the at least one mobile computing device;
determining the update package for the at least one mobile computing device; and
pushing the update package to the at least one mobile computing device.

14. The computer implemented method of claim 11, wherein publishing the plurality of topics is achieved through an implementation of XEP-0060 protocol.

15. The computer implemented method of claim 11, wherein each group of mobile computing devices comprises a group of mobile computing devices in a geographical location.

16. A computer readable storage medium storing instructions implementing a method for managing load on an update server, the update server used to update software on mobile computing devices, the instructions when executed by a processor cause the processor to:
publish a plurality of topics for a plurality of corresponding groups of mobile computing devices, wherein at least one mobile computing device of each group is pre-configured subscriber of at least one topic from the plurality of topics;
receive, from the at least one mobile computing device, information about an application on the at least one mobile computing device;
determine an update package for the at least one mobile computing device using the received information;
compile the update package for the at least one mobile computing device;
inform the at least one mobile device about the compiled update package through the at least one topic;
receive an update request from the at least one mobile computing device; and
transmit, in response to receiving the update request, the compiled update package to the at least one mobile computing device.

17. The computer readable storage medium of claim 16, wherein inform further comprises inform in a sequential order the at least one mobile device of each group about the compiled update package.

18. The computer readable storage medium of claim 16, wherein the processor executes an implementation of XEP-0060 protocol to publish the plurality of topics.

19. The computer readable storage medium of claim 16, wherein the information about the application is a version number of the application present on the at least one mobile computing device.

20. The computer readable storage medium of claim 16, wherein each group of mobile computing devices comprises a group of mobile computing devices in a geographical location.

21. A computer readable storage medium storing instructions implementing a method for exchanging information with a mobile computing device, the instructions when executed by a processor cause the processor to:
store an identification tag and a password for the mobile computing device;
create a private topic for the mobile computing device using the identification tag and the password;
publish the private topic for the mobile computing device;
receive, from the mobile computing device, the identification tag and the password;
grant a subscription to the private topic to the mobile computing device in response to the received identification tag and the password matching the stored identification tag and the stored password; and
transmit information on the private topic to the mobile computing device.

22. The computer readable storage medium of claim 21, wherein the identification tag and the password uniquely identify the mobile computing device.

23. The computer readable storage medium of claim 21, wherein the information is billing information.

24. The computer readable storage medium of claim 21, wherein the processor executes an implementation of XEP-0060 protocol t to publish the private topic.

25. The computer readable storage medium of claim 21, wherein the information is destined for a particular module in the mobile computing device and the information contains an appID corresponding to the particular module.
